(19) United States
(12) Patent Application Publication
(10) Pub. No.: US 2014/0028879 A1
(43) Pub. Date: Jan. 30, 2014

(54) IMAGE PROCESSING DEVICE, IMAGE PROCESSING METHOD, AND SOLID-STATE IMAGING DEVICE

(71) Applicant: KABUSHIKI KAISHA TOSHIBA, Tokyo (JP)

(72) Inventors: Hiroaki MORINO, Tokyo (JP); Junichi Hosokawa, Kanagawa (JP); Ryuki Sato, Tokyo (JP)

(73) Assignee: Kabushiki Kaisha Toshiba, Tokyo (JP)

(21) Appl. No.: 13/780,209

(22) Filed: Feb. 28, 2013

(30) Foreign Application Priority Data
Jul. 25, 2012 (JP) 2012-164854

(51) Int. Cl. G06T 5/00; H04N 5/357

(52) U.S. Cl. CPC G06T 5/007; H04N 5/357
USPC 348/241; 382/266

(57) ABSTRACT

According to an embodiment, an image processing device includes a vertical contour extraction unit, a horizontal contour extraction unit, an edge strength judgment unit, and a dynamic adjustment unit. The edge strength judgment unit outputs an edge strength signal by judgment of strength of an edge included in a pixel block. The dynamic adjustment unit performs dynamic adjustment on a vertical contour signal and a horizontal contour signal in accordance with the edge strength signal.

### CROSS-REFERENCE TO RELATED APPLICATIONS

This application is based upon and claims the benefit of priority from Japanese Patent Application No. 2012-164854, filed on Jul. 25, 2012; the entire contents of which are incorporated herein by reference.

### FIELD

Embodiments relate generally to an image processing device, an image processing method, and a solid-state imaging device.

### BACKGROUND

According to the related art, as a contour enhancement process on a subject image by digital signal processing, for example, methods are known in which a contour component of a predetermined band extracted with a bandpass filter (BPF) is subjected to a predetermined process, the contour component is set as a contour enhancement signal, and the contour enhancement signal is added to an image signal. When a sharp contour is attempted to be acquired, not only the contour of a subject but also minute shading present in a flat portion such as a skin or a wall surface may be enhanced by increasing the degree of the contour enhancement, and thus an unnatural rough surface may be produced in some cases.

### BRIEF DESCRIPTION OF THE DRAWINGS

FIG. 1 is a block diagram illustrating the overall configuration of a digital signal processor which is an image processing device according to an embodiment;

FIG. 2 is a block diagram illustrating the overall configuration of a digital camera including a DSP illustrated in FIG. 1;

FIG. 3 is a block diagram illustrating the overall configuration of a solid-state imaging device;

FIG. 4 is a block diagram illustrating the configuration of a contour enhancement signal generation unit;

FIG. 5 is a block diagram illustrating the configuration of an edge strength judgment unit;

FIG. 6 is a diagram illustrating contour enhancement for a contour;

FIG. 7 is a diagram illustrating contour enhancement when not only a contour but also a flat portion in which minute shading is present are included; and

FIG. 8 is a diagram illustrating application of a contour enhancement signal generated by the contour enhancement signal generation unit according to the embodiment.

### DETAILED DESCRIPTION

In general, according to an embodiment, an image processing device includes a vertical contour extraction unit, a horizontal contour extraction unit, an edge strength judgment unit, and a dynamic adjustment unit. The vertical contour extraction unit extracts a contour component in a vertical direction of a subject image from an image signal acquired through capturing of the subject image and sets the extracted contour component as a vertical contour signal. The horizontal contour extraction unit extracts a contour component in a horizontal direction of the subject image from the image signal and sets the extracted contour component as a horizontal contour signal. The edge strength judgment unit outputs an edge strength signal by judgment of strength of an edge included in a pixel block. The pixel block is constituted by a plurality of pixels. The dynamic adjustment unit performs dynamic adjustment on the vertical contour signal and the horizontal contour signal in accordance with the edge strength signal.

Hereinafter, an image processing device, an image processing method, and a solid-state imaging device according to an embodiment will be described in detail with reference to the appended drawings. The present invention is not limited to the embodiment.

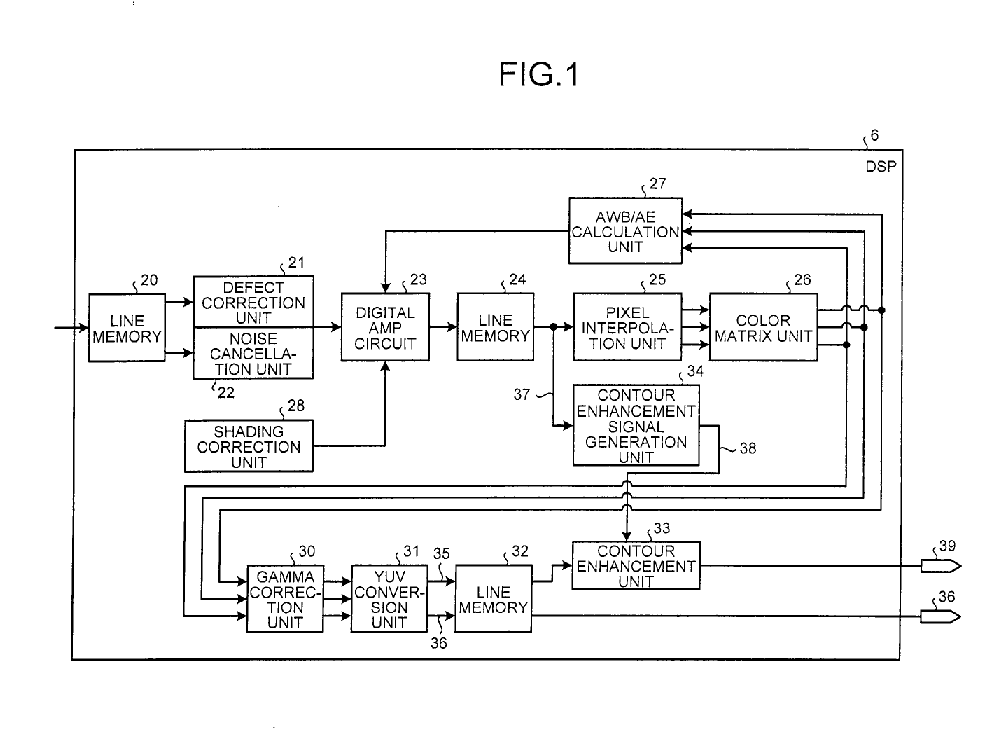

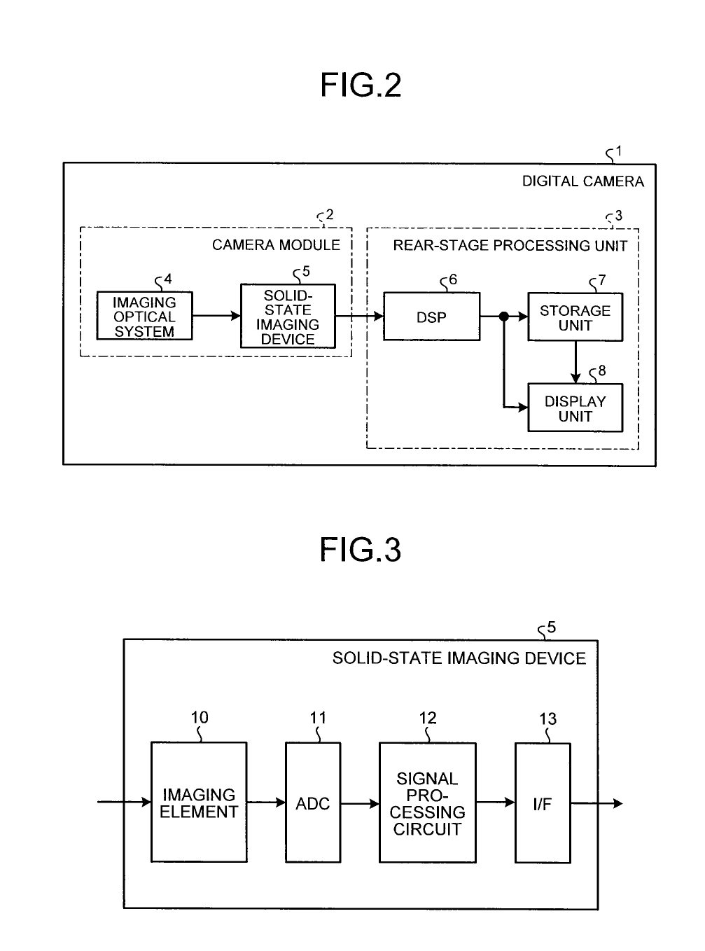

FIG. 1 is a block diagram illustrating the overall configuration of a DSP (digital signal processor) which is an image processing device according to an embodiment. FIG. 2 is a block diagram illustrating the overall configuration of a digital camera including the DSP illustrated in FIG. 1.

A digital camera 1 includes a camera module 2 and a rear-stage processing unit 3. The camera module 2 includes an imaging optical system 4 and a solid-state imaging device 5. The rear-stage processing unit 3 includes a DSP 6, a storage unit 7, and a display unit 8. The camera module 2 is applied not only to the digital camera 1 but also to, for example, an electronic device such as a camera-attached portable terminal.

The imaging optical system 4 acquires light from a subject and forms a subject image. The solid-state imaging device 5 captures the subject image. The DSP 6 performs signal processing on an image signal acquired through the imaging performed by the solid-state imaging device 5. The storage unit 7 stores an image subjected to the signal processing by the DSP 6. The storage unit 7 outputs the image signal to the display unit 8 in response to a user's operation or the like. The display unit 8 displays the image according to the image signal input from the DSP 6 or the storage unit 7. The display unit 8 is, for example, a liquid crystal display.

FIG. 3 is a block diagram illustrating the overall configuration of the solid-state imaging device. The solid-state imaging device 5 is, for example, a CMOS (complementary metal oxide semiconductor) image sensor. The solid-state imaging device 5 may be a CCD (charge coupled device) as well as the CMOS image sensor. The solid-state imaging device 5 includes an imaging element 10, an ADC (analog-to-digital converter) 11, a signal processing circuit 12, and an I/F (interface) 13.

In the imaging element 10, the light acquired by the imaging optical system 4 is converted into a signal charge by a photodiode. For example, the imaging element 10 generates an analog image signal by acquiring signal values of R (red), G (green), and B (blue) in the order corresponding to a Bayer array. The ADC 11 converts the image signal from the imaging element 10 from an analogy system to a digital system.

The signal processing circuit 12 performs various kinds of signal processing on the digital image signal input from the ADC 11. The I/F 13 outputs an image signal subjected to the signal processing by the signal processing circuit 12. The I/F 13 may perform conversion from a serial input to a parallel output or conversion from a parallel input to a serial output.

A line memory 20 illustrated in FIG. 1 temporarily stores the digital image signal input from the camera module 2 to the rear-stage processing unit 3. A defect correction unit 21 and a noise cancellation unit 22 share the line memory 20. The defect correction unit 21 performs defect correction on the digital image signal from the line memory 20. The defect correction unit 21 corrects a defective portion (defect) of the digital image signal caused due to a pixel which does not normally function in the solid-state imaging device 5. The noise cancellation unit 22 performs a noise cancellation process to reduce noise. The shading correction unit 28 calculates a shading correction coefficient for the shading correction of the subject image.

A digital amplifier (AMP) circuit 23 calculates a digital AMP coefficient based on a coefficient calculated by an AWB/AE calculation unit 27 to be described below and the shading correction coefficient calculated by the shading correction unit 28. Further, the digital AMP circuit 23 multiplies the digital image signal subjected to the processes of the defect correction unit 21 and the noise cancellation unit 22 by the digital AMP coefficient.

A line memory 24 temporarily stores the digital image signal multiplied by the digital AMP coefficient. A pixel interpolation unit 25 generates an RGB signal (sensitivity signal) through an interpolation process (de-mosaic process) on the digital image signal delivered in the order of the Bayer array from the line memory 24.

A color matrix unit 26 performs a color matrix calculation process (color reproducibility process) on the sensitivity signal of RGB to obtain color reproducibility. The AWB/AE calculation unit 27 calculates coefficients used for AWB (auto white balance) adjustment and AE (auto exposure) adjustment from the sensitivity signal of RGB.

A gamma correction unit 30 performs gamma correction on the sensitivity signal of RGB to correct the gradation of an image. A YUV conversion unit 31 converts the image signal from an RGB format to a YUV format (for example, YUV 422) by generating a luminance (Y) signal 35 and a color difference (UV) signal 36 from the sensitivity signal of RGB. The YUV conversion unit 31 converts the sensitivity signal of each color component into the Y signal 35 and the UV signal 36. A line memory 32 temporarily stores the Y signal 35 and the UV signal 36 from the YUV conversion unit 31.

A contour enhancement signal generation unit 34 generates a contour enhancement signal 38 from RAW image data 37 read from the line memory 24. The RAW image data 37 is assumed to be an image signal subjected to the signal processing of each unit from the acquisition by the capturing of the subject image in the solid-state imaging device 5 (see FIG. 3) to arrival to the contour enhancement signal generation unit 34.

A contour enhancement unit 33 performs a contour enhancement process on the Y signal 35 read from the line memory 32. The contour enhancement unit 33 adds a contour enhancement signal 38 input from the contour enhancement signal generation unit 34 to the Y signal 35 as the contour enhancement process. The contour enhancement unit 33 uses, for example, a correction coefficient calculated based on an imaging condition of the solid-state imaging device 5 and the position of each pixel in the contour enhancement process.

The DSP 6 outputs the Y signal 39 subjected to the contour enhancement process by the contour enhancement unit 33 and the UV signal 36 from the line memory 32. The configuration of the DSP 6 described in this embodiment is merely an example and may be appropriately modified. For example, in the DSP 6, other elements different from the elements described in this embodiment may be added or elements which can be omitted may not be provided.

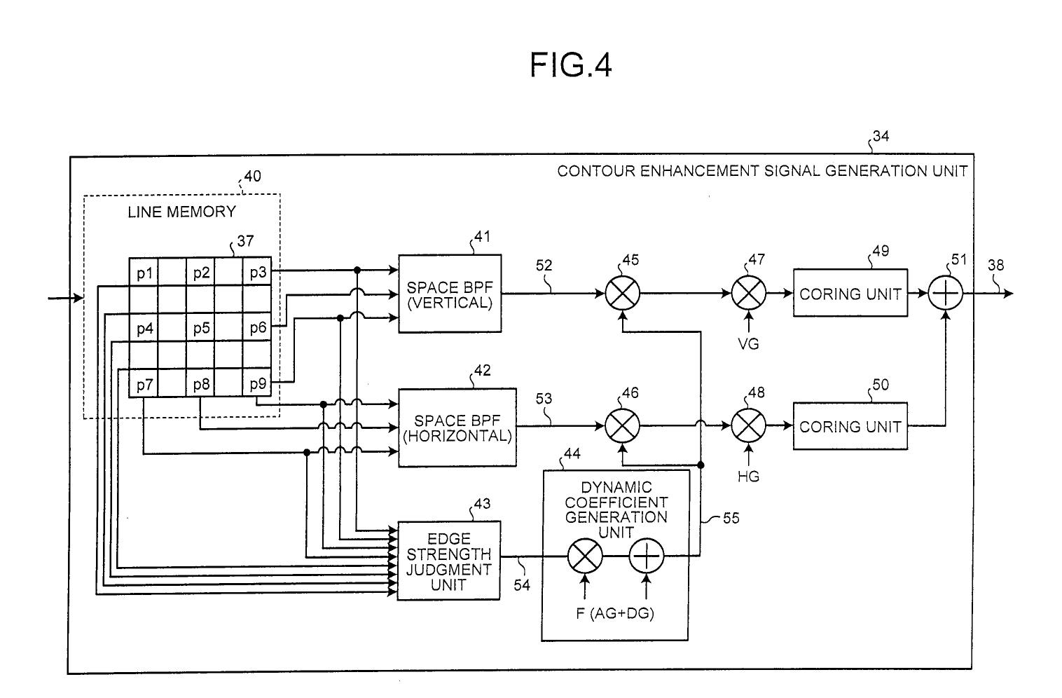

FIG. 4 is a block diagram illustrating the configuration of the contour enhancement signal generation unit. The contour enhancement signal generation unit 34 includes a line memory 40, space BPFs 41 and 42, an edge strength judgment unit 43, a dynamic coefficient generation unit 44, multipliers 45, 46, 47, and 48, coring units 49 and 50, and an adder 51.

The line memory 40 retains the RAW image data 37 input from the line memory 24 (see FIG. 1) to the contour enhancement signal generation unit 34. For example, the line memory 40 retains a digital image signal corresponding to four lines. In this embodiment, the contour enhancement signal generation unit 34 generates the contour enhancement signal 38 for each pixel block of 5×5 pixels in four lines retained by the line memory 40 and one line immediately before input to the line memory 40.

The pixel block includes a middle pixel p5 and eight peripheral pixels p1, p2, p3, p4, p6, p7, p8, and p9. The middle pixel p5 and the peripheral pixels p1, p2, p3, p4, p6, p7, p8, and p9 are all pixels of the same color. The middle pixel p5 is located in the middle of the pixel block. The peripheral pixels p1, p2, p3, p4, p6, p7, p8, and p9 are located in the periphery distant by one pixel from the middle pixel p5. The contour enhancement signal generation unit 34 generates a contour enhancement signal to be applied to the middle pixel p5 using pixel data of the nine pixels p1 to p9 of the same color.

The space BPF 41 extracts a contour component in the vertical direction of the subject image from the pixel data of the nine pixels p1 to p9. The space BPF 41 outputs the extracted contour component as a vertical contour signal 52. The space BPF 41 functions as a vertical contour extraction unit.

The space BPF 42 extracts a contour component in the horizontal direction of the subject image from the pixel data of the nine pixels p1 to p9. The space BPF 42 outputs the extracted contour component as a horizontal contour signal 53. The space BPF 42 functions as a horizontal contour extraction unit.

An edge strength judgment unit 43 judges the strength of an edge included in the pixel block. Here, the edge refers to a portion in which lightness is discontinuous. In regard to the strength of the edge, acuteness of the change in the lightness in the subject image is assumed to be evaluated. The edge strength judgment unit 43 outputs the judgment result as an edge strength signal 54. A dynamic coefficient generation unit 44 calculates a coefficient F (AG+DG) interlocking with an analog gain (AG) and a digital gain (DG) of the image signal.

The dynamic coefficient generation unit 44 generates a dynamic coefficient 55 by performing adjustment of a gain and an offset using the coefficient F (AG+DG) on the edge strength signal 54. A dynamic coefficient 55 is a coefficient which interlocks with the AG and the DG and corresponds to the edge strength signal 54.

The dynamic coefficient generation unit 44 may perform adjustment of at least one of the gain and the offset using the coefficient F (AG+DG) on the edge strength signal 54. The dynamic coefficient 55 may interlock with at least one of the AG and the DG. The dynamic coefficient generation unit 44 may arbitrarily set the way how the dynamic coefficient 55 interlocks with the AG and the DG. For example, the dynamic coefficient generation unit 44 may set the way how the dynamic coefficient 55 interlocks with the AG and the DG by determining whether the dynamic coefficient 55 increases or decreases as the AG and the DG increases, depending on the characteristics of the solid-state imaging device 5.

The multiplier 45 multiplies the vertical contour signal 52 from the space BPF 41 by the dynamic coefficient 55 from the dynamic coefficient generation unit 44. The multiplier 46 multiplies the horizontal contour signal 53 from the space BPF 42 by the dynamic coefficient 55 from the dynamic coefficient generation unit 44. The multipliers 45 and 46 function as a dynamic coefficient multiplication unit.

The dynamic coefficient generation unit 44 and the multipliers 45 and 46 performs dynamic adjustment of the vertical contour signal 52 and the horizontal contour signal 53 by the dynamic coefficient 55 according to the edge strength signal 54. The dynamic coefficient generation unit 44 and the multipliers 45 and 46 function as a dynamic adjustment unit.

The multiplier 47 multiplies the vertical contour signal 52 multiplied by the dynamic coefficient 55 in the multiplier 45 by a vertical gain VG. The vertical gain VG is assumed to be a gain set for a contour component in the vertical direction.

The multiplier 48 multiplies the horizontal contour signal 53 multiplied by the dynamic coefficient 55 in the multiplier 46 by a horizontal gain HG. The horizontal gain HG is assumed to be a gain set for a contour component in the horizontal direction.

The coring unit 49 performs a coring process on the vertical contour signal 52 multiplied by the vertical gain VG by in multiplier 47. The coring unit 49 performs, as the coring process, a process of uniformly setting the signal level of a component with an amplitude smaller than a predetermined coring level serving as a threshold value in the vertical contour signal 52 to be zero. The coring unit 49 subtracts the coring level from the signal level of a component with an amplitude greater than the coring level in the vertical contour signal 52. The coring unit 49 suppresses the enhancement of noise by removing a noise component among the contour components in the vertical direction through the coring process.

The coring unit 50 performs a coring process on the horizontal contour signal 53 multiplied by the horizontal gain HG in the multiplier 48. The coring unit 50 performs, as the coring process, a process of uniformly setting the signal level of a component with an amplitude smaller than a predetermined coring level serving as a threshold value in the horizontal contour signal 53 to be zero. The coring unit 50 subtracts the coring level from the signal level of a component with an amplitude greater than the coring level in the horizontal contour signal 53. The coring unit 50 suppresses the enhancement of noise by removing a noise component among the contour components in the horizontal direction through the coring process.

The adder 51 adds the vertical contour signal 52 subjected to the coring process by the coring unit 49 and the horizontal contour signal 53 subjected to the coring process by the coring unit 50. The contour enhancement signal generation unit 34 outputs the addition result of the adder 51 as a contour enhancement signal 38.

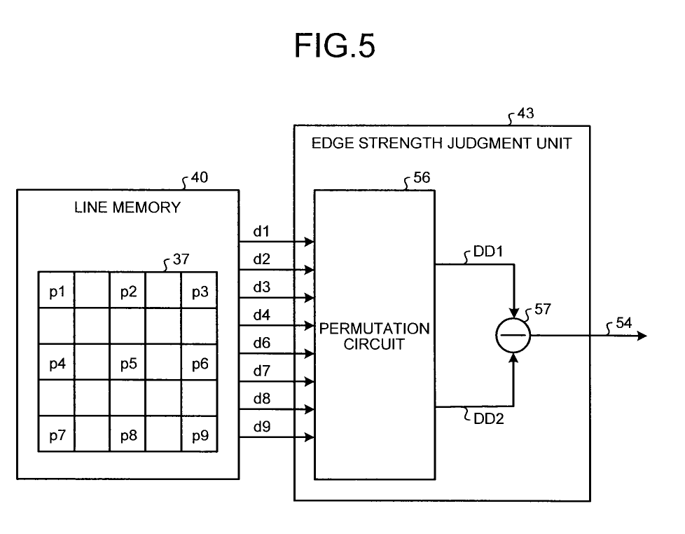

FIG. 5 is a block diagram illustrating the configuration of the edge strength judgment unit. The edge strength judgment unit 43 includes a permutation circuit 56 and a subtracter 57. The RAW image data 37 in the line memory 40 includes nine pixels p1 to p9 and pixel data d1 to d9.

The permutation circuit 56 permutes the pixel data d1, d2, d3, d4, d6, d7, d8, and d9 of the peripheral pixels p1, p2, p3, p4, p6, p7, p8, and p9 among the pixel data d1 to d9 according to the signal level. The permutation circuit 56 performs the permutation excluding the pixel data d5 of the middle pixel p5.

The permutation circuit 56 outputs first pixel data DD1 and second pixel data DD2. The first pixel data DD1 is assumed to be, for example, pixel data specified secondly from the highest signal level among the pixel data d1, d2, d3, d4, d6, d7, d8, and d9. The second pixel data DD2 is assumed to be, for example, pixel data specified secondly from the lowest signal level among the pixel data d1, d2, d3, d4, d6, d7, d8, and d9.

The subtracter 57 calculates a difference between the first pixel data DD1 and the second pixel data DD2 specified by the permutation of the permutation circuit 56. The edge strength judgment unit 43 outputs the difference calculated by the subtracter 57 as an edge strength signal 54.

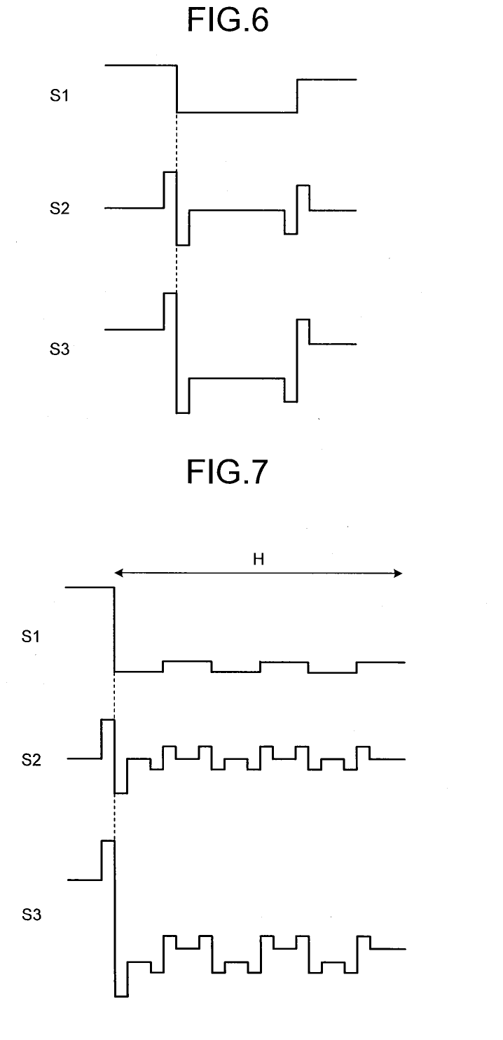

FIG. 6 is a diagram illustrating the contour enhancement for the contour. An image signal S1 before the contour enhancement includes a step difference of the signal level corresponding to the contour of the subject image. An overshoot obtained by increasing the signal level and an undershoot obtained by decreasing the signal level are granted to a contour enhancement signal S2 obtained from the image signal S1 before and after the step difference of the signal level of the image signal S1.

In an image signal S3 after the contour enhancement obtained by adding the image signal S1 and the contour enhancement signal S2, the step difference of the signal level in the contour is enhanced by the addition of the signal level corresponding to the overshoot and the subtraction of the signal level corresponding to the undershoot.

FIG. 7 is a diagram illustrating the contour enhancement when not only the contour but also a flat portion in which minute shading is present are included. In an image signal S1 before the contour enhancement, a signal level is assumed to slightly vary in correspondence with the minute shading of the flat portion of the subject during a period H in which the step difference corresponding to the contour continues. For example, the minute shading refers to a change in contrast unnoticed compared to the contour of an object such as minute unevenness expressed by texture of a wall surface, a skin, a cloth, or the like.

When a contour enhancement signal S2 is generated through the same process on both the contour and the flat portion in the case of the image signal S1, the overshoot and the undershoot for which the signal level is changed at the same ratio are granted to the contour and the minute shading. With an image signal S3 after the contour enhancement obtained by adding the image signal S1 and the contour enhancement signal S2, not only the contour but also the minute shading of the flat portion may be enhanced. In this case, not only the contour of a portion to be enhanced but also the shading of a portion to be smooth may be enhanced by the contour enhancement signal S2, and thus an unnatural rough surface or the like may be produced in the flat portion.

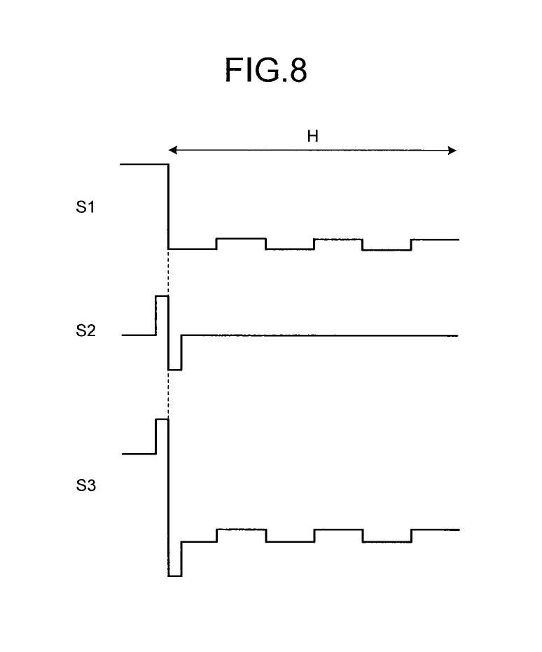

FIG. 8 is a diagram illustrating application of the contour enhancement signal generated by the contour enhancement signal generation unit according to this embodiment. The contour enhancement signal generation unit 34 can generate the contour enhancement signal S2 of which the signal level is adjusted according to the strength of the edge by performing the dynamic adjustment on the vertical contour signal 52 and the horizontal contour signal 53 according to the edge strength signal 54.

The contour enhancement signal generation unit 34 grants the overshoot and the undershoot, for which the step difference of the signal level can be sufficiently amplified, to the contour enhancement signal S2 for the contour of which the signal level is considerably changed in regard to the image signal S1 illustrated in FIG. 7. Further, the contour enhancement signal generation unit 34 sets the signal level of the contour enhancement signal S2 to be, for example, zero in regard to the shading in which the change in the signal level is slight.

The change in the signal level of the image signal S3 after the contour enhancement obtained by adding the image signal S1 and the contour enhancement signal S2 is amplified for the contour, and the change in the signal level is suppressed for the flat portion equivalently, as in the original image signal S1. Thus, the DSP 6 can obtain a clear and natural image, sufficiently enhancing the contour for a portion to be enhanced and suppressing the unnecessary enhancement of a portion to be smooth by applying the contour enhancement signal generation unit 34.

The edge strength judgment unit 43 excludes the pixel data with the highest signal level and the lowest signal level as the pixel data to be used to generate the edge strength signal 54. The edge strength judgment unit 43 generates the edge strength signal 54 excluding a component of which a signal level is the maximum or minimum in units of pixels, for example, information regarding a flaw or a dot stripe. The contour enhancement signal generation unit 34 avoids erroneous recognition in which such a component different from the contour is recognized as the contour, and can perform the dynamic adjustment of the vertical contour signal 52 and the horizontal contour signal 53.

For example, when a line-shaped front end portion which does not correspond to the contour is present within the range of the pixel block, the pixel data d5 of the middle pixel p5 and one of the pixel data d1, d2, d3, d4, d6, d7, d8, and d9 of the peripheral pixels p1, p2, p3, p4, p6, p7, p8, and p9 have the highest signal level and the second highest signal level in some cases. When the contour enhancement is performed on such a portion by similarly treating the portion as a normal contour, unnaturalness may be intensified.

The edge strength judgment unit 43 excludes the pixel data d5 of the middle pixel p5 in advance from the targets of the pixel data used to generate the edge strength signal 54 and generates the edge strength signal 54. The contour enhancement signal generation unit 34 avoids erroneous recognition in which such a component is recognized as the contour, and can perform the dynamic adjustment of the vertical contour signal 52 and the horizontal contour signal 53. Accordingly, the DSP 6 can obtain an image in which the unnaturalness is reduced by this countermeasure.

The edge strength judgment unit 43 is not limited to the judgment of the strength of an edge included in the pixel block of 5×5 pixels. The edge strength judgment unit 43 may judge the strength of the edge from the pixel block of at least a plurality of pixels. The edge strength judgment unit 43 is not limited to the generation of the edge strength signal 54 based on the pixel data of 9 pixels (3×3 pixels) of the same color. The edge strength judgment unit 43 may generate the edge strength signal 54 based on pixel data of a larger number of pixels such as pixel data of 25 pixels (5×5 pixels) of the same color or pixel data of 49 pixels (7×7 pixels).

The edge strength judgment unit 43 may apply pixel data with a signal level equal to or lower than the third highest signal level as the first pixel data. The edge strength judgment unit 43 may apply pixel data with a signal level equal to or higher than the third lowest signal level as the second pixel data. Pixel data with an m^{th} signal level from the highest signal level may be set as the first pixel data, and pixel data with an n^{th} signal level from the lowest signal level may be set as the second pixel data. At least one of m and n may be an integer equal to or greater than 2. Further, m and n may be the same as each other or may be different from each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a vertical contour extraction unit that extracts a contour component in a vertical direction of a subject image from an image signal acquired through capturing of the subject image and sets the extracted contour component as a vertical contour signal;
a horizontal contour extraction unit that extracts a contour component in a horizontal direction of the subject image from the image signal and sets the extracted contour component as a horizontal contour signal;
an edge strength judgment unit that outputs an edge strength signal by judgment of strength of an edge included in a pixel block composed of a plurality of pixels; and
a dynamic adjustment unit that performs dynamic adjustment on the vertical contour signal and the horizontal contour signal in accordance with the edge strength signal.

2. The image processing device according to claim 1, wherein the dynamic adjustment unit includes
a dynamic coefficient generation unit that generates a dynamic coefficient in accordance with the edge strength signal and in interlock with an analog gain of the image signal, and
a dynamic coefficient multiplication unit that multiplies the vertical contour signal and the horizontal contour signal by the dynamic coefficient.

3. The image processing device according to claim 1, wherein the dynamic adjustment unit includes
a dynamic coefficient generation unit that generates a dynamic coefficient in accordance with the edge strength signal and in interlock with a digital gain of the image signal, and
a dynamic coefficient multiplication unit that multiplies the vertical contour signal and the horizontal contour signal by the dynamic coefficient.

4. The image processing device according to claim 1, wherein the edge strength judgment unit reads pixel data of pixels with the same color as a middle pixel located in a middle of the pixel block in the pixel block and outputs, as the edge strength signal, a difference between first pixel data with an m^{th} (where, m is an integer equal to or greater than 2) signal level from the highest signal level and second pixel data with an n^{th} (where, n is an integer equal to or greater than 2) signal level from the lowest signal level.

5. The image processing device according to claim 4,
wherein the first pixel data is the pixel data with a second signal level from the highest signal level, and
the second pixel data is the pixel data with a second signal level from the lowest signal level.

6. The image processing device according to claim 4,
wherein the edge strength judgment unit includes a permutation circuit that permutates the read pixel data in accordance with a signal level and specifies the first pixel data and the second pixel data, and
the permutation circuit performs the permutation excluding the pixel data of the middle pixel.

7. The image processing device according to claim 1, further comprising:
a coring unit that performs a coring process on the vertical contour signal and the horizontal contour signal subjected to the dynamic adjustment by the dynamic adjustment unit.

8. The image processing device according to claim 1,
wherein the vertical contour extraction unit, the horizontal contour extraction unit, the edge strength judgment unit, and the dynamic adjustment unit configure a contour enhancement generation unit that generates a contour enhancement signal, and
the contour enhancement generation unit outputs, as the contour enhancement signal, an addition result of the vertical contour signal and the horizontal contour signal subjected to the dynamic adjustment by the dynamic adjustment unit.

9. An image processing method comprising:
extracting a contour component in a vertical direction of a subject image as a vertical contour signal from an image signal acquired through capturing of the subject image;
extracting a contour component in a horizontal direction of the subject image as a horizontal contour signal from the image signal;
performing edge strength judgment to judge a strength of an edge included in a pixel block composed of a plurality of pixels; and
performing dynamic adjustment of the vertical contour signal and the horizontal contour signal in accordance with an edge strength signal indicating a result of the edge strength judgment.

10. The image processing method according to claim 9, wherein the dynamic adjustment includes
generating a dynamic coefficient in accordance with the edge strength signal and in interlock with an analog gain of the image signal, and
multiplying the vertical contour signal and the horizontal contour signal by the dynamic coefficient.

11. The image processing method according to claim 9, wherein the dynamic adjustment includes
generating a dynamic coefficient in accordance with the edge strength signal in interlock with a digital gain of the image signal, and
multiplying the vertical contour signal and the horizontal contour signal by the dynamic coefficient.

12. The image processing method according to claim 9, wherein the edge strength judgment includes
reading pixel data of pixels with the same color as a middle pixel located in a middle of the pixel block in the pixel block, and
outputting, as the edge strength signal, a difference between first pixel data with an m^{th} (where, m is an integer equal to or greater than 2) signal level from the highest signal level and second pixel data with an n^{th} (where, n is an integer equal to or greater than 2) signal level from the lowest signal level.

13. The image processing method according to claim 12,
wherein the first pixel data is the pixel data with a second signal level from the highest signal level, and
the second pixel data is the pixel data with a second signal level from the lowest signal level.

14. The image processing method according to claim 12,
wherein the edge strength judgment includes permutating the read pixel data in accordance with a signal level and specifying the first pixel data and the second pixel data, and
in the permutating of the pixel data, the pixel data of the middle pixel is excluded.

15. The image processing method according to claim 9, further comprising:
performing a coring process on the vertical contour signal and the horizontal contour signal subjected to the dynamic adjustment.

16. The image processing method according to claim 9, further comprising:
setting an addition result of the vertical contour signal and the horizontal contour signal subjected to the dynamic adjustment as the contour enhancement signal; and
performing a contour enhancement process using the contour enhancement signal.

17. A solid-state imaging device comprising:
an image sensor that captures a subject image;
a contour enhancement signal generation unit that generates a contour enhancement signal from an image signal acquired through capturing of the subject image; and
a contour enhancement unit that performs a contour enhancement process on the image signal using the contour enhancement signal generated by the contour enhancement signal generation unit,
wherein the contour enhancement signal generation unit includes
a vertical contour extraction unit that extracts a contour component in a vertical direction of the subject image from the image signal and sets the extracted contour component as a vertical contour signal,
a horizontal contour extraction unit that extracts a contour component in a horizontal direction of the subject image from the image signal and sets the extracted contour component as a horizontal contour signal,
an edge strength judgment unit that outputs an edge strength signal by judgment of strength of an edge included in a pixel block composed of a plurality of pixels, and
a dynamic adjustment unit that performs dynamic adjustment on the vertical contour signal and the horizontal contour signal in accordance with the edge strength signal.

18. The solid-state imaging device according to claim 17, wherein the dynamic adjustment unit includes
a dynamic coefficient generation unit that generates a dynamic coefficient in accordance with the edge strength signal and in interlock with at least one of an analog gain and a digital gain of the image signal, and
a dynamic coefficient multiplication unit that multiplies the vertical contour signal and the horizontal contour signal by the dynamic coefficient.

19. The solid-state imaging device according to claim 17, wherein the edge strength judgment unit reads pixel data of pixels with the same color as a middle pixel located in a middle of the pixel block in the pixel block and outputs, as the edge strength signal, a difference between first pixel data with an m^{th} (where, m is an integer equal to or greater than 2) signal level from the highest signal level and second pixel data with an n^{th} (where, n is an integer equal to or greater than 2) signal level from the lowest signal level.

20. The solid-state imaging device according to claim 19,
wherein the edge strength judgment unit includes a permutation circuit that permutates the read pixel data in accordance with a signal level and specifies the first pixel data and the second pixel data, and
the permutation circuit performs the permutation excluding the pixel data of the middle pixel.
